(19) United States
(12) Patent Application Publication
(10) Pub. No.: US 2015/0166086 A1
(43) Pub. Date: Jun. 18, 2015

(54) WINDSHIELD DISPLAY SYSTEM

(71) Applicant: ELECTRO-MOTIVE DIESEL, INC., La Grange, IL (US)

(72) Inventor: Scott M. Branka, St. Charles, IL (US)

(73) Assignee: ELECTRO-MOTIVE DIESEL, INC., La Grange, IL (US)

(21) Appl. No.: 14/629,503

(22) Filed: Feb. 24, 2015

(51) Int. Cl. B61L 15/00; G02B 27/01

(52) U.S. Cl. CPC B61L 15/0072; G02B 27/01

(57) ABSTRACT

In one aspect of the present disclosure, a display system for a locomotive is shown. The display systems includes: a windshield, a substantially transparent operator display panel, and a controller. The windshield is configured to facilitate an operator view of a railway track. The substantially transparent operator display panel is operatively coupled to the windshield and adapted to allow an operator to view the railway track. The control system is in communication with the operator display panel within an operator work station and configured to generate an image associated with control of the locomotive. The control system is in communication with the operator display panel within an operator work station and configured to output the image onto the operator display panel to enable a simultaneous view of the image and the operator view of the railway track.

### TECHNICAL FIELD

The present disclosure relates generally to a display system for a vehicle, and more particularly, to a system which includes a display system and a windshield used for operation of a locomotive.

### BACKGROUND

Generally, a display system that is positioned within an operator work station of a vehicle may be used to provide vehicle information such as operating and management information. An operator of a locomotive may use such information during travel to monitor various conditions such as PTC (Positive Train Control), dynamic braking, speed, air brake, length of train, throttle notch settings, fuel quantity, indicator for end of train, indicator for headlights on, activation of the alerter, and tractive effort.

However, due to a limit in available work space, there is a need to configure supplementary space to display other information within the operator work station. Additional information is also needed by the operator for locomotive operations that may become difficult to exhibit within the present limited space within the locomotive cab.

U.S. Pat. No. 7,796,056 to Fein, et. al. discloses a digital windshield information system. The digital windshield information system discloses a typical environment in the front seat of a motor vehicle, including a windshield, rear view mirror, steering wheel, and dashboard. The digital windshield information system also includes a GPS (Global Positioning System), a control panel, speakers, a voice activation microphone, and a system display area located at the windshield. A display device is configured to present information within the windshield of the motor vehicle.

While this digital windshield information system of Fein may be capable of having the display device present information to the windshield, this system may be difficult and costly to service because the display device is integrated into the windshield system display area.

The present disclosure is directed to overcoming one or more problems set forth above and/or problems of the prior art.

### SUMMARY OF THE DISCLOSURE

In one aspect of the present disclosure, a display system for a locomotive is shown. The display system for a locomotive includes a windshield configured to facilitate an operator view of a railway track. The display system also includes a substantially transparent operator display panel operatively coupled to the windshield and adapted to allow the operator to view the railway track straight. Additionally, the display system includes a control system in communication with the operator display panel within an operator work station and configured to generate an image associated with control of the locomotive. Further, the control system is configured to output the image onto the operator display panel to enable a simultaneous view of the image and the operator view of the railway track.

Other features and aspects of this disclosure will be apparent from the following description and the accompanying drawings.

### BRIEF DESCRIPTION OF THE DRAWINGS

FIG. 1A is a perspective view of a locomotive having a windshield according to one embodiment of the present disclosure;

FIG. 1B is a cut-a-way view of a locomotive taken along the operator work station section, illustrating a display system that may be used for a locomotive, according to one embodiment of the present disclosure;

FIG. 2A is an illustration of the display system where a display panel may be attached to a windshield for a locomotive, according to one embodiment of the present disclosure;

FIG. 2B is an illustration of an exploded view of one embodiment of the display panel, where the display panel slides into a frame that may be attached to the windshield for a locomotive;

FIG. 2C is an illustration of an exploded view of another embodiment of the display panel, where the display panel may be secured to the windshield for a locomotive with a bolt and nut assembly; and

FIG. 3 is a block level illustration of the display system that may be used for a locomotive, according to one embodiment of the present disclosure.

### DETAILED DESCRIPTION

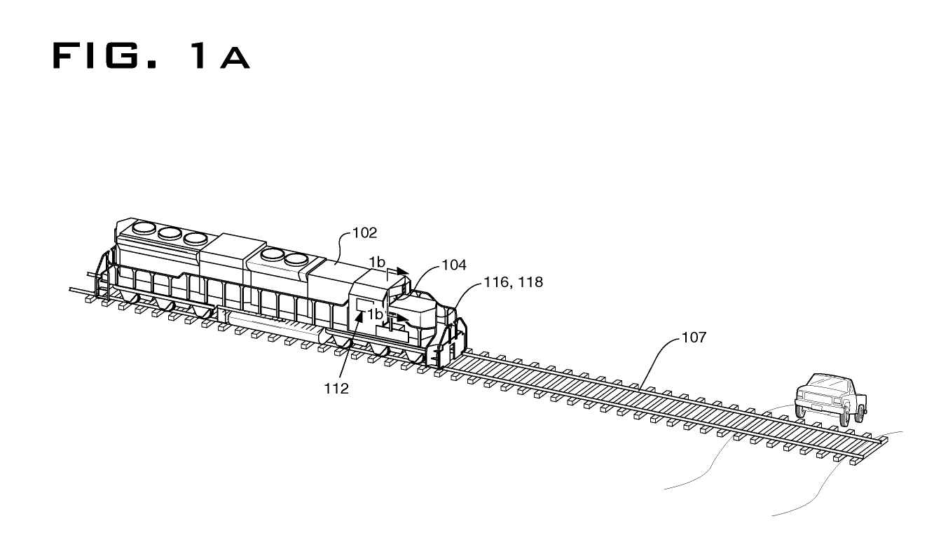

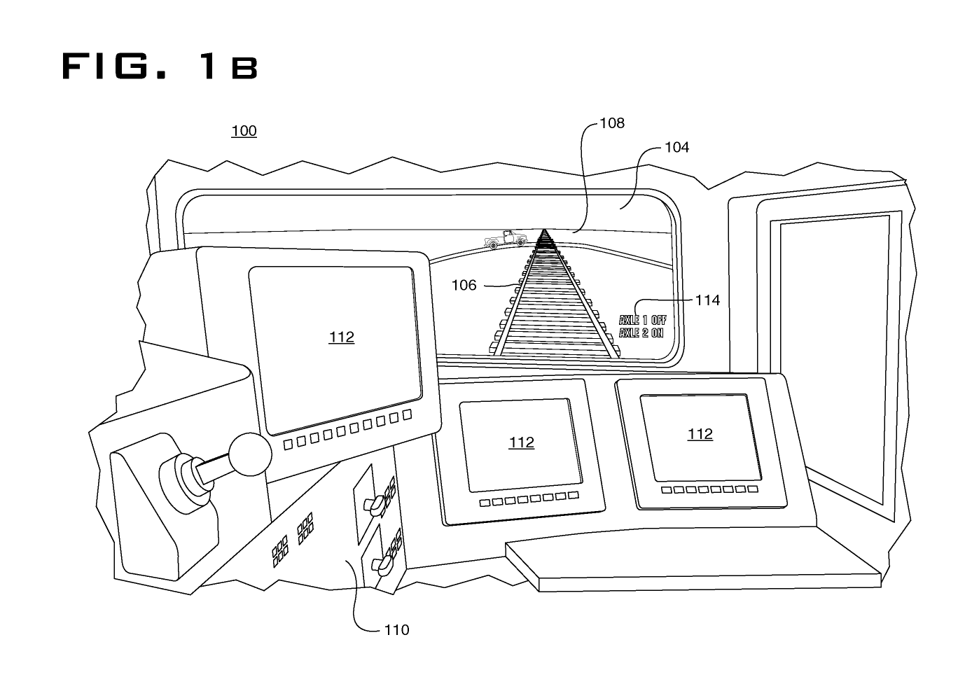

FIG. 1A illustrates a locomotive 102 having a windshield 104 and an operator work station 112.

FIG. 1B illustrates a cut-away view of the locomotive 102, taken at the operator work station 112, illustrating a display system 100 that may be used for the locomotive 102. The display system 100 includes the windshield 104, an operator display panel 108, and a control system 110.

The windshield 104 is configured to facilitate an operator view of a railway track 106. The windshield 104 may be made of a material that meets the minimum requirements for glazing materials for protection of railroad operators and passengers from injury, as a result of objects that may strike the windshield 104. The operator view of the railway track 106 may provide an undistorted right-of-way view of the railway track 107 (as shown in FIG. 1A), while the operator is seated in the locomotive 102. The operator view of the railway track 106 may include the railway track 107 ahead at a proximate linear distance in front of the locomotive 102, as well as lateral distances proximately located on either side of the railway track 107.

In one embodiment, the operator view of the railway track 106 at night or during low visibility conditions may be enhanced if the locomotive 102 is equipped with one or more infrared sensors 116 or cameras 118 (as shown in FIG. 1A) that may be front-mounted for viewing conditions of railway track 107. The infrared sensors 116 or cameras 118 may be positioned inside or outside of the operator cab of the locomotive 102. The infrared sensors 116 or cameras 118 capture and send signals indicative of thermal images 114 associated with objects that may be on the railway track 107 to the display system 100. Those captured signals may then be projected to the display system 100 as a virtual image in the operator's field of sight. The display system 100 may also permit an enhanced view of the railway track 107 beyond a range which is visible to the operator via the locomotive headlights.

The operator display panel 108 may be substantially transparent and operatively coupled to the windshield 104 and adapted to allow an operator a view of the railway track 106 straight ahead. The operator display panel 108 may be made of single or multiple glass panels or other similar materials. In one embodiment, the operator display panel 108 may consist of an LCD display or displays. In another embodiment, the operator display panel 108 may consist of an arrangement of an Organic Light-Emitting Diode (OLED) panel inserted between two glass panels that are sealed to complete a display. Because of the semi-conducting nature of OLEDs, light is emitted when electrically stimulated.

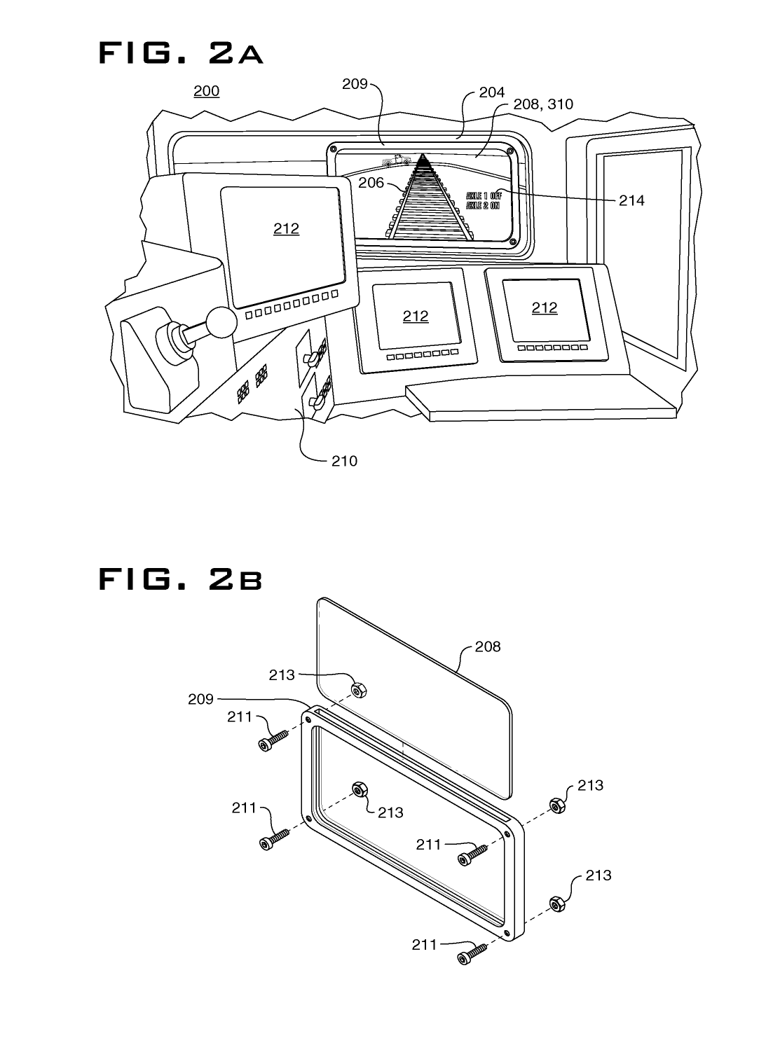

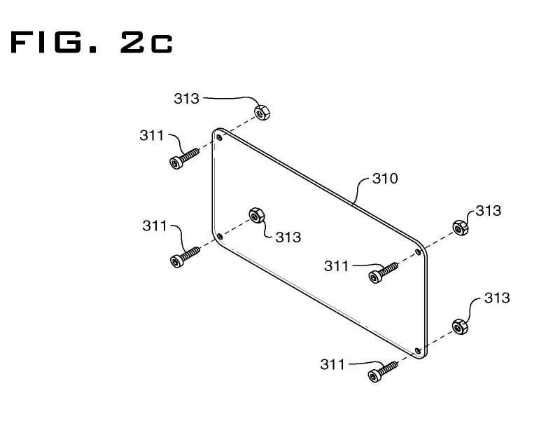

As shown in FIG. 2A, an operator display panel 208, 310 within a display system 200 may be operatively coupled to a windshield 204. The operator display panel 208, 310 located within an operator work station 212 with a control system 210 may be substantially transparent and may be capable of sliding into a window type frame 209 that opens from the top of the frame as illustrated in FIG. 2B. This window type frame 209 is also capable of sustaining the weight of the operator display panel 208 and is securely fastened to the windshield 204 by a bolt 211 and a nut 213 assembly. In an exemplary embodiment, the operator display system 200 may also contain an operator view of railway track 206 and image 214. Alternately, the operator display panel 310 (as shown in FIG. 2C) may be secured to the windshield 204 directly by a bolt 311 and a nut 313 assembly or similar type fastening device as illustrated in FIG. 2C. Further, the operator display panel 208, 310 may occupy a part or substantially all of the space within the windshield 204.

### INDUSTRIAL APPLICABILITY

A locomotive may have a limited space for the display of data within the cab for supplemental information, such as a warning of objects on or near the track ahead. Also, the operator may have a limited view of the track ahead during night and low visibility conditions that does not exceed the operating range of locomotive headlights. If this occurs, the operator may be unable to make the most efficient operating decisions or avoid potential objects on or near the track ahead. Thus, there is a need for a transparent display system that is capable of receiving additional information and is operatively coupled to the windshield of a locomotive that provides a simultaneous view of the image and the operator view of railway track.

In the present disclosure, FIG. 1A illustrates a final assembly of the display system 100 that may be used for operating the locomotive 102, according to one embodiment of the present disclosure. Herein, the windshield 104 is configured to facilitate the operator view of the railway track 106. Also, the operator display panel 108 is engaged to the windshield 104, such that it permits the operator to view the railway track 106 straight ahead. In full operation, the control system 110 is in communication with the operator display panel 108 within an operator work station 112 and is configured to generate the thermal images 114 associated with control of the locomotive 102. Further, the control system 110 is in communication with the operator display panel 108 within an operator work station 112 and configured to output the thermal images 114 onto the operator display panel 108 to enable a simultaneous view of the thermal images 114 and the operator view of railway track 106.

In operation, the control system 110 is in communication with operator display panel 108 within operator work station 112 and is configured to generate thermal images 114 associated with control of the locomotive 102. The control system 110 may have a single or multiple processors. The control system 110 is configured to receive information data via control signals. For instance, data is sent via control signals initiated through electrical devices that transmit to displays within the operator work station 112. This data may include: PTC, speed, air brake, length of train, and fuel quantity. However, this data bypasses the operator display panel 108. Similarly, the data sent via control signals may be initiated through mechanical devices that transmit to displays within the operator work station 112 via the use of throttles, handles, levers, dials, press down buttons, switches or the like. This data may include: throttle notch settings, dynamic braking, indicator for lights on, activation of the alerter, and tractive effort. However, this data bypasses the operator display panel 108. Additionally, the control system 110 is configured to receive supplemental data via control signals such as individual axle control and activation of AESS (Automatic Engine Start Stop). However, this supplemental data may also include warning information communicated from sensors that detect objects or hazards on the track. For instance, the control system 110 is adapted to receive position information from thermal images and responsively deliver a signal directly to the operator display panel 108, thus displaying virtual images that may be located on or proximately on either side of the track ahead.

The control system 110 is in communication with the operator display panel 108 within operator work station 112 and is configured to output thermal images 114 onto the operator display panel 108 to enable a simultaneous view of the thermal images 114 and the operator view of the railway track 106. For example, the control system 110 via its processor outputs the supplemental information data as thermal images 114 that are overlaid onto the operator display panel 108 on the windshield 104 of the locomotive 102. This is accomplished in such a manner that an operator seated at the operator work station 112 of the locomotive 102, has a simultaneous view of the thermal images 114 on the operator display panel 108 and the operator view of the railway track 106 ahead. In another embodiment, the thermal images 114 may be displayed as virtual images on the face of the operator display panel 108. In another embodiment, the thermal images 114 may be displayed in color or in black or white on the operator display panel 108. In another embodiment, the thermal images 114 may be digitally displayed on the operator display panel 108.

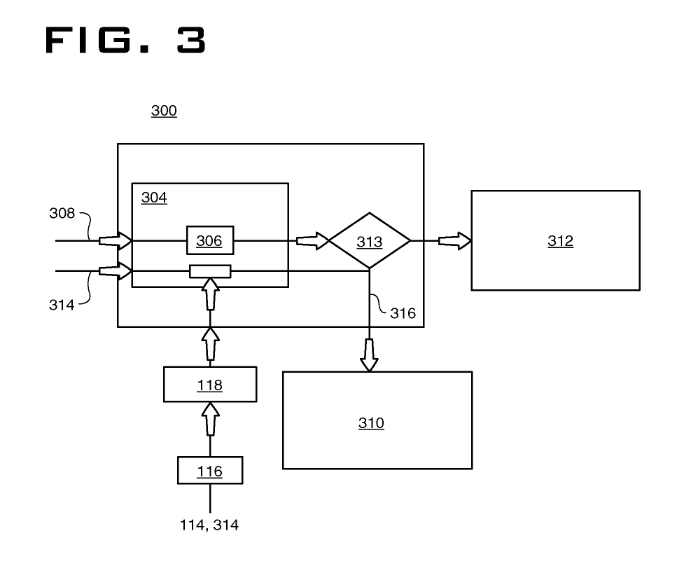

FIG. 3 is a block level illustration of a display system 300 that may be used for a locomotive, according to one embodiment of the present disclosure. As shown, a control system 304 has a processor 306 that is configured to receive a data 308 via control signals. The processor 306 transmits the data 308 in a manner that bypasses the operator display panel 310 and displays within the operator work station displays 312 in the locomotive when the processor 306 sends it through a bypass filter 313. The processor 306 is also configured to receive supplemental data 314 via control signals. This supplemental data 314 may include positional information of thermal images 316, 114 captured from infrared sensors 116 or cameras 118. However, this supplemental data 314 is transmitted directly to the operator display panel 310 that is coupled to the windshield of the locomotive. The control system 304 via the processor 306 outputs supplemental data 314 that generates an image 322 that is displayed onto the operator display panel 310 when it passes through the bypass filter 313.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A display system for a locomotive comprising:
a windshield configured to facilitate an operator view of a railway track;
a substantially transparent operator display panel operatively coupled to the windshield and adapted to allow the operator to view the railway track;
a control system in communication with the operator display panel within an operator work station and configured to:
generate an image associated with control of the locomotive, and
output the image onto the operator display panel to enable a simultaneous view of the image and the operator view of the railway track.
